(19) United States
(12) Patent Application Publication
(10) Pub. No.: US 2019/0155946 A1
(43) Pub. Date: May 23, 2019

(54) N-GRAM CLASSIFICATION IN SOCIAL MEDIA MESSAGES

(71) Applicant: Colossio, Inc., Chicago, IL (US)

(72) Inventor: Joseph A. Jaroch, Chicago, IL (US)

(21) Appl. No.: 15/817,505

(22) Filed: Nov. 20, 2017

(51) Int. Cl. G06F 17/30

(52) U.S. Cl. CPC G06F 17/30707; G06F 17/30887; G06F 17/30896

(57) ABSTRACT

Systems and a method for n-gram classification of social media content are provided. In one or more aspects, a system includes a network interface to receive the social media content from a social media network. The social media content includes a string of characters. A processor can process the string of characters by parsing the string of characters and resolving encodings by removing markup characters from the string of characters. The processor further extracts non-text sub strings from the string of characters, and tokenizes the string of characters into separate words.

### TECHNICAL FIELD

The present disclosure generally relates to computational linguistic and more specifically relates to n-gram classification in social media messages.

### BACKGROUND

Data posted on social media represents some of the richest insight into real-time thought, which can be useful for many users such as business entities. For example, various organizations may be interested in understanding their user-base who are known to post information on social media. The information posted on social media may include rich content, such as emoji, emoticons, URLs, and multi-media content. However, lack of structures may make the data in the social media posts unapproachable and/or intractable.

Some current solutions for accessing content in social media posts may look into parsed data, for example, by extracting stemmed versions of words (e.g., removing the “ing” from “removing” to leave “remove”). This may allow content data to be handled in a more straightforward manner as fewer discrete database entries are required to classify the data, but may result in losing a considerable amount of depth in context. Additionally, some existing solutions may strip contractions and other apostrophized words, for example, leaving “don't” as “don”, which may pollute the meaning of a given piece of text. In other words, employing existing solutions to extract content from social media posts can be difficult and cumbersome. Therefore, a more efficient and platform-agnostic solution for processing social media data with integrity is desired.

### SUMMARY

The disclosed system and methods are provided for classifying social media content and identifying users' interests. The subject technology can utilize a variety of convolutional neural network tools to perform N-gram classification of social media content (e.g., messages). The disclosed solution takes a different approach from the existing solutions by changing the way in which data is processed to ensure maximum integrity while remaining platform agnostic.

According to certain aspects of the present disclosure, a system for n-gram classification of social media content includes a network interface to receive the social media content from a social media network. The social media content includes a string of characters. A processor can process the string of characters by parsing the string of characters and resolving encodings by removing markup characters from the string of characters. The processor further extracts non-text sub strings from the string of characters, and tokenizes the string of characters into separate words.

According to certain aspects of the present disclosure, a method of n-gram classification of social media content includes receiving, via a network interface, the social media content including a first string of characters from a social media network. The method further includes processing, by a processor, the first string of characters in a single pass to generate a second string of characters and a metadata. The processing may include parsing the first string of characters, resolving encodings by removing markup characters from the first string of characters, extracting non-text substrings from the first string of characters; and tokenizing the first string of characters into separate words forming the second string of characters.

According to certain aspects of the present disclosure, a system may include memory and a processor coupled to the memory. The processor can receive social media content including a string of characters from a social media network. The processor is further configured to process the string of characters in a single pass by parsing the string of characters, removing encodings from the string of characters, and extracting non-text substrings including uniform resource locators (URLs) from the string of characters.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment in which the subject technology is implemented.

FIG. 2 is a flow diagram illustrating an example process for n-gram classification of social media content, according to certain aspects of the disclosure.

FIG. 3 is a flow diagram illustrating an example process for identifying entities in tokenized media content, according to certain aspects of the disclosure.

FIG. 4 is a flow diagram illustrating an example process for processing hashtags in media content, according to certain aspects of the disclosure.

FIG. 5 is a flow diagram illustrating an example process for identifying sentiments in tokenized media content, according to certain aspects of the disclosure.

FIG. 6 is a diagram illustrating an example implementation of n-gram classification of social media content, according to certain aspects of the disclosure.

FIG. 7 is a flow diagram illustrating an example method of n-gram classification of social media content, according to certain aspects of the disclosure.

FIG. 8 is a block diagram illustrating an example computer system with which certain aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

This subject technology provides a method and a system for classifying social media content and identifying users' interests. The subject technology can utilize a variety of convolutional neural network tools (e.g., Caffe, TensorFlow and Theano) to perform n-gram classification of social media content (e.g., messages). The disclosed solution takes a different approach from the existing solutions by changing the way in which data is processed to ensure maximum integrity while remaining platform agnostic. The subject technology processes user messages to eliminate, for example, markup characters such as hyper-text markup language (HTML) and to leave the message content intact, while making it straightforward for further parsing and insight seeking.

The subject technology may receive a firehose (e.g., accessing a Twitter firehose that can push data to end users in real-time) of user data across an entire social network (e.g., Twitter, Facebook and LinkedIn). In some implementations, the subject solution may be used to analyze a single user's entire history of posted content (e.g., messages). The posted contents may include user identifications (IDs) and timestamps of each message. Social networks generally do not extract more complex features from each message as doing so may requires the establishment of a knowledgebase and deeper subject matter context.

In one or more implementations, of the subject technology, the received social media content can be parsed with multiple approaches in a single pass. First, any markup characters (e.g., HTML, encoding, etc.) are removed and normalized. It is noted that some social networks do not normalize inputs such as “The&amp;nbsp;String”, which may, for example, require two iterations to turn into “The String”.

After this basic input normalization, various components are extracted from the normalized content and stored in separate tables for further precise inspection. Uniform Resource Locators (URLs) are extracted and removed as the query-strings could negatively impact the accuracy of sentiment analysis. URLs may take several different forms (e.g., HTML code, raw http/https links and shortened URLs), each of which has to be covered to ensure an effective extraction.

In some implementations, hashtags and mentions (identified by “@username”) are then removed, the usernames are utilized for identifying the user's relationships and hashtags are parsed further for deeper insights. Hashtags may be split into their constituent words via several different methods. For example, hashtags can take the form of mixed case (e.g., HashTag), where words are delineated by a change in case, irregular case (e.g., hashTAG), where words vary arbitrarily or no case changes (e.g., hashtag). It is understood that the human brain is exceptionally good at matching patterns of known words, which makes parsing these hashtags straightforward for humans. The process for software may be considerably more intense.

In one or more implementations, the disclosed process may first break apart a hashtag by case and then further break apart the case-separated components.

In one some implementations, emoji and emoticons are extracted and normalized, with the full range of emoticons being translated to textual representations of their graphics. Because some characters are shared between emoticons and URLs, these processing steps have to be performed in the correct order to prevent incorrectly flagging arbitrary data as emoticons. Elongated words are then found and shortened.

In one or more implementations, the content string may be split into words by using a group of common delimiters. The group intentionally omits apostrophes and hyphens, which can affect to the meaning of the word. Once the string is split, named entities are heuristically extracted by looking at each word and checking if it exists in a database of known common words. If the word does not exist in the database, the word can be a candidate entity. When two or more adjacent candidate entities exist in the string, they are reported as a possible entity group. The entity might be a company name, a personal name, a product, a location, or any other important noun. Further refinements to the reported entities can be performed, but the initial pass allows for coarse visibility into the user's interests.

With the message split into discrete words, the message content can be classified. The collection of words is iterated and compared against a dictionary, which includes various classifications for unigrams (e.g., single words) and n-grams (e.g., sets of multiple words), as described in more detail herein.

A particular use-case for the disclosed solution is to normalize and classify unstructured data from social media to ascribe scores to phrases to infer interests and other information about a particular person. This allows organizations to circumvent the need for running heavyweight and unscalable surveys across a large number of users by enabling them to automatically derive insights from public posts of their user-base on social media.

The subject technology allows an interested party (e.g., a business entity) to identify, from users' publicly available posted content, trends and interests associated with a large portion of their user-base, for example, watching a particular TV show. The business entity may decide to place advertisements on that TV show to potentially increase sales. Without the data and insight obtained by the subject technology, it would have not been possible to achieve the sales increase without heavyweight and unscalable surveys.

### Example System Architecture

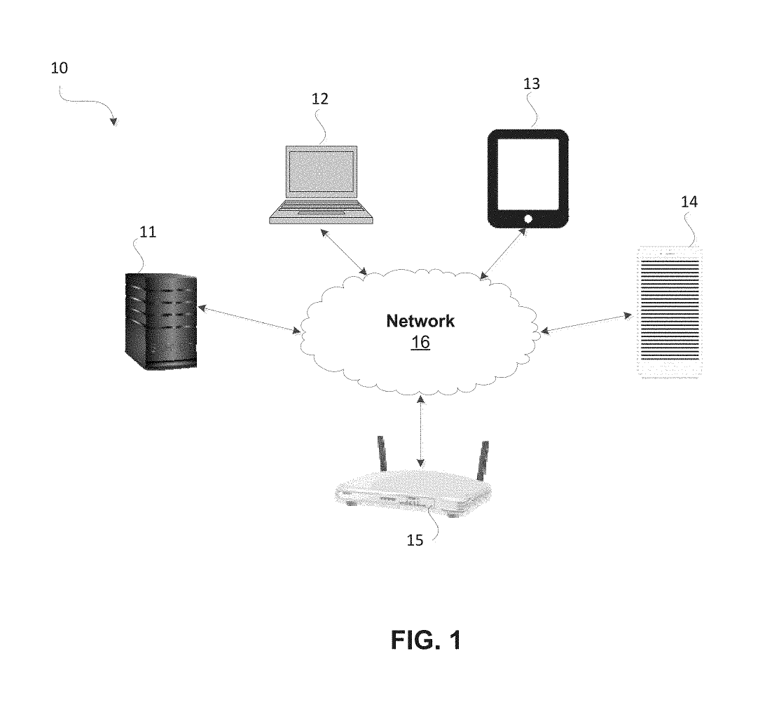

FIG. 1 illustrates an example environment in which the subject technology is implemented. The architecture 10 includes a server 11, a computing device 13, portable communication devices 13 and 14 and an access point 15 communicating (e.g., wirelessly) over a network 16. In some implementations, the server 11 is a local server or a cloud server capable of cloud computing. The computing device 12 may be a personal computer such as a laptop computer, the portable communication device 13 may be a tablet and the portable communication device 14 may be a smart phone or a personal digital assistant (PDA). The access point 15 may be a wireless access point that facilitates communication, via the network 16, of the server 11, the computing device 12 and the portable communication devices 13 and 14.

Examples of the network 16 include any one or more of a personal area network (PAN), a local area network (LAN), a campus area network (CAN), a metropolitan area network (MAN), a wide area network (WAN), a virtual private network (VPN), a broadband network (BBN), the Internet and the like. Further, the network 16 can include, but is not limited to, any one or more of the following network topologies, including a bus network, a star network, a ring network, a mesh network, a star-bus network, a tree or hierarchical network and the like.

In some implementations, the server 11 can receive and process a number of media content such as social media messages from one or more social media networks (e.g., Facebook, Twitter, LinkedIn and the like). In one or more implementations, any of the computing device 13 and/or the portable communication devices 13 and 14 may communicate messages over the social media networks. In some aspects, the computing device 13 and/or the portable communication devices 13 and 14 may have capabilities, such as processing power and one or more suitable applications to perform processing of the media content as described herein. In some embodiments, the processing of the social media content may be implemented in one or more of the server 11, the computing device 13 and/or the portable communication devices 13 and 14.

In some implementations, the processing of the social media content may include n-gram classification of social media content (e.g., a message such as a Tweet) including a first string of characters from a social media network (e.g., Twitter). For example, a network interface of the server 11 may receive the social media content including a first string of characters from a social media network. A processor of the server 11 may perform the processing (e.g., n-gram classification) of the first string of characters in a single pass and generate a second string of characters and metadata. The processor parses the first string of characters and resolves encodings by removing markup characters from the first string of characters. The processor may remove non-text sub strings from the first string of characters, and tokenize the first string of characters into separate words to generate the second string of characters, as described in more detail herein.

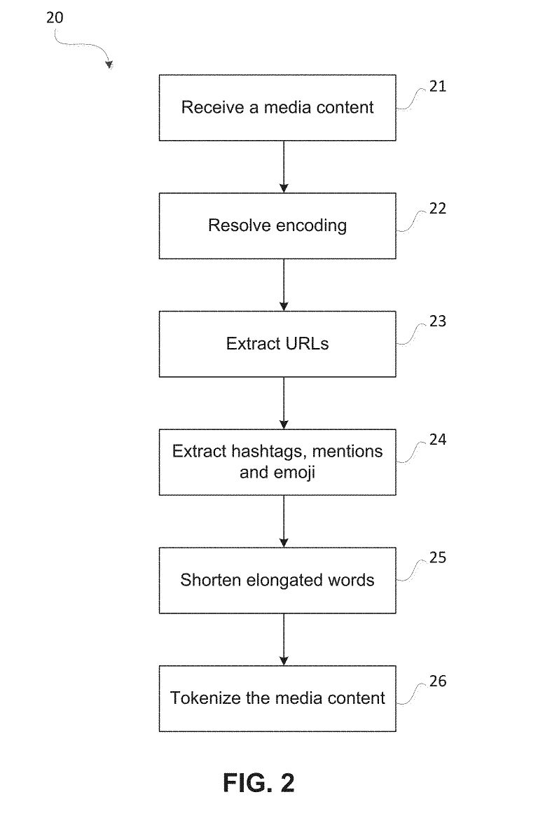

FIG. 2 is a flow diagram illustrating an example process 20 for n-gram classification of social media content, according to certain aspects of the disclosure. The process 20 starts at operation block 21, where media content (e.g., a message such as a Tweet) is received by the server 11 of FIG. 1 from a social network via the network 16 of FIG. 1. At operation block 22, a processor of the server 11 resolves encoding of the message by first parsing the message and then removing markup characters such as HTML and other encodings that may include important information about the rest of the strings in the message. For example, when an encoded version of an ampersand (&) is encountered, removing the encoding can reveal the ampersand and allows identification of characters following the ampersand as a mention.

At operation block 23, non-text substrings such as the URLs are extracted to prevent negative impact of the query-strings on the accuracy of sentiment analysis from the first string. The URLs may appear in a number of different forms (e.g., HTML code, raw http/https links and shortened URLs), each of which has to be identified and extracted. At operation block 24, other non-text substrings including hashtag, mentions and emoticons are identified and extracted. For example, a hashtag is identified as strings followed by the hashtag character (#), and a mention is identified by “@username”, where username is the name of a Twitter user. The username can be utilized to identify the user's relationship, and hashtags are parsed further for deeper insights. In some implementations, the processor may split a hashtag into corresponding constituent words via a number of different methods, as further described herein.

Further, the processor (e.g., of server 11) extracts emoticons (e.g., emoji) before normalizing the string. In some implementations, a full range of emoticons are translated into textual representations of their graphics. It is understood that some characters may be shared between emoticons and URLs. Accordingly, these processing steps of removing URLs and emoticons have to be performed in a correct order to prevent erroneously flagging arbitrary data as emoticons.

In some implementations, the processor stores a position of the extracted non-text substrings in the string of characters to allow a granular identification of applicable sentiments at a per-sentence or a per-phrase level. The non-text substrings extracted in operation blocks 23 and 24 can be aggregated and stored as metadata in separate tables for further precise inspection.

At operation block 25, the processor finds and shortens elongated words. For example, words such as “gooooal”, “Yeeeees”, and “Nooooo” may be introduced by users to indicate enthusiasm and/or emphasis. The precise elongation, however, may vary from one user to the other and can prevent important elements of sentiment from contributing properly. The processor may iterate through the word, looking for duplicated adjacent letters, and remove duplicate letters until the word matches a known word within a database of known words. The processor may flag the word as being emphasized, which may aid in giving insight into the overall meaning of the media content. At operation block 26, the processor may tokenize the content string by splitting the string into words by using a group of common delimiters. The processor may intentionally omit apostrophes and hyphens, which can affect to the meaning of the word. Once the string is split, named entities are heuristically extracted by looking at each word and checking if it exists in a database of known common words. If the word does not exist in the database, the word can be a candidate entity, as discussed further below.

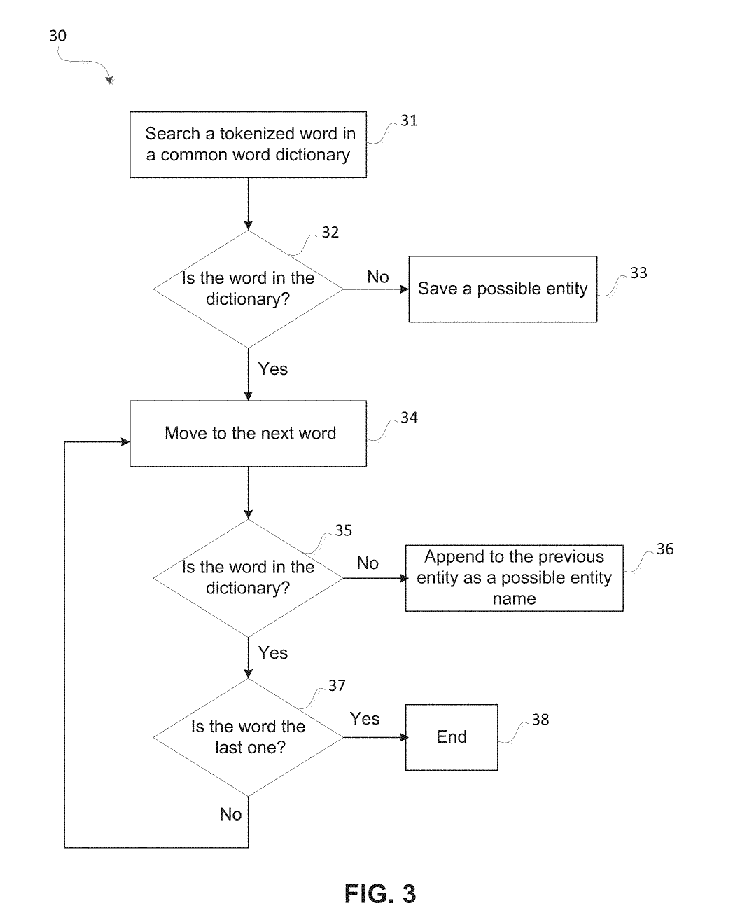

FIG. 3 is a flow diagram illustrating an example process 30 for identifying entities in tokenized media content, according to certain aspects of the disclosure. The process 30 starts with the operation block 31, where after tokenizing the string by splitting the string into words, the processor searches a tokenized word in the database of known common words (e.g., a special dictionary) using, for example, a brute force method. At control operation block 32, if the tokenized word does not exist in the database, at operation block 33, the processor stores the word as a possible entity name. Otherwise, if the tokenized word does exist in the database, at operation block 34, the search is performed for the next word in the string.

At control operation block 35, the next word is checked against the database and if the word is not in the database, at operation block 36, the processor may append the word to the previous entity name as a possible new entity name. Otherwise, if the word exists in the database, at control operation block 37, the processor checks whether the word is the last word of the string. If the word is the last word of the string, the process ends (38). Otherwise, if the word is not the last word of the string, the control is passed to operation block 34 to continue the search. When two or more adjacent candidate entities exist in the string, they may be stored as a possible entity group name. The entity might be a company name, a personal name, a product, a location, or any other important noun. Further refinements to the stored entity names can be performed, but the initial pass allows for a coarse visibility into the user's interests.

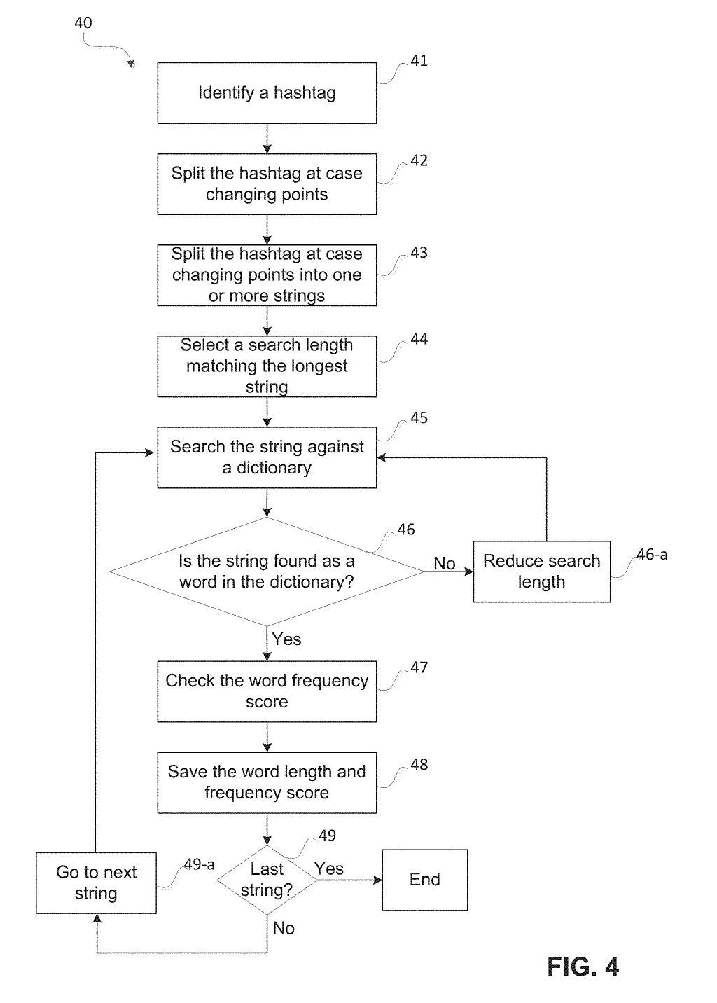

FIG. 4 is a flow diagram illustrating an example process 40 for processing hashtags in media content, according to certain aspects of the disclosure. The processor 11 of FIG. 1 may process the hashtags by splitting them into separate words, for example, using fuzzy heuristics. The process 40 starts at operation 41, where the processor (e.g., of server 11 of FIG. 1) identifies a hashtag as a group of strings following a hashtag character. The hashtag may be a mixed case substring (e.g., “HashTag”), where words are delineated by a change in case, an irregular case (e.g., “hashTAG”), where words vary arbitrarily or with no case changes (e.g., “hashtag”). At operation block 42, the processor splits the identified hashtag at case changing points. In one or more implementations, the processor, at operation block 43, may break apart the case-separated components of the hashtag into a number of substrings. At operation block 44, the processor may select a search length (e.g., the length of a search substring) that matches the longest substring. At operation block 45, the processor uses the search length to search a dictionary of words.

The processor may iterate through the components of the hashtag by decreasing the search length on each iteration, and comparing the substring against a dictionary of known words. The dictionary of know words may include the frequency of words as observed across the Internet, which allows prioritizing some words above others. For example, at control operation block 46, it is determined whether the search string is not found in the dictionary. If the search string is not found in the dictionary, at operation block 46-a the search length is reduced and the control is passed to the operation block 45. Otherwise, if the search string is found in the dictionary, at operation block 47 the word frequency score is obtained and at operation block 48, the search length and the frequency score of the search string is stored as metadata. At control operation block 49, the processor checks to see if the searched word was the last word in the identified hashtag. If the searched word was not the last word in the identified hashtag, at operation block 49-a, the pointer is moved to the next word and control is passed to operation block 45. Otherwise, if the searched word was the last word in the identified hashtag, the process 40 ends.

In some aspects, a hashtag can have non-dictionary words intermixed with dictionary words, so the recursive parsing may have to identify the best match. The best match, for example, may be identified as the match with the fewest number of discrete words and the highest average frequency score. This ensures that, for example, a substring “forthewin” is broken into “for the win” instead of “fort he win” as “fort” is a far less common word than “for” and the phrase “for the” is a much more common phrase than “fort he”.

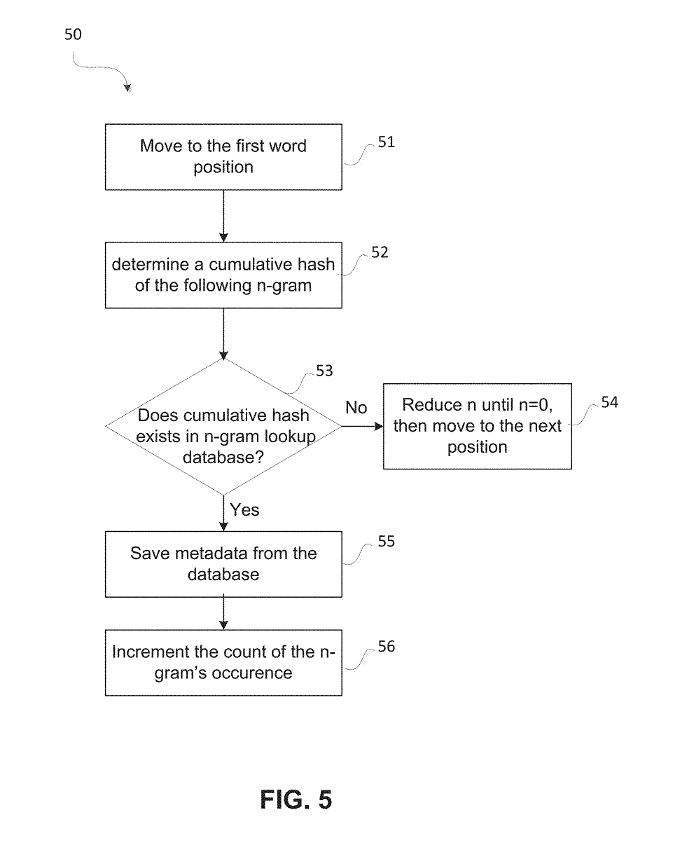

FIG. 5 is a flow diagram illustrating an example process 50 for identifying sentiments in tokenized media content, according to certain aspects of the disclosure. In general, the process 50 walks across the set of words, trying to find the longest matches possible but reducing the distance of each match as it moves forward (e.g., trying to match five words, then four, then three, then moving forward and trying five again, then four, then three, etc.). This process when done on actual words may not be efficient. The efficiency can be improved by using a cumulative hash as described below.

The process 50 begins, at operation block 51, by starting from the first word position in a tokenized string generated by the process 20 of FIG. 2. At operation block 52, a cumulative hash of a following n-gram is determined to be searched instead of the actual words. The processor (e.g., of the server 11 of FIG. 11) may compute a hash for each word of the tokenized string and then combine the computed hashes. At control operation block 53, the processor searches an n-gram look-up database to check if the combined (accumulated) hash can be found in the database. This process is significantly more efficient than searching the corresponding group of words in a dictionary. If the combined hash cannot be found in the database, at operation block 54, n is reduced until n=0 is reached and the pointer is moved to a next position. For example, if the starting n was 5 (e.g., a 5-gram) and the combined hash for the 5 words was not found, n is reduced to 4, and the hash still not found continue the process to reach n=0. If the combined hash was found in the database, at operation block 55, the processor stores the metadata from the database, and finally at operation block 56, the count of the n-gram's occurrence is incremented. The process may iterate through different values of n.

Alongside each unigram and n-gram, the database holds a single record which includes the metadata. For example, the metadata may include full set of relevant information such as score, sentiment data, personality insight scoring flags, and other in-depth classification data. The scores may be held as floating points and stored in name-value pairs for easy consumption. In one or more implementations, once each of the n-gram scores are found, the processor may store the n-gram scores in a metadata record alongside the content. This allows higher level consumers to get quick insight into each dimension of classification of the processed media content (e.g., message). In some implementations, the n-gram classification of the subject technology can be implemented by using a variety of available convolutional neural network tools such as Caffe, TensorFlow and Theano.

Because the disclosed solution processes the message in a single pass, and the entire insights are available at once from this single pass, the efficiency of the subject system is vastly higher than systems that would need to iterate over a given message multiple times to formulate an opinion.

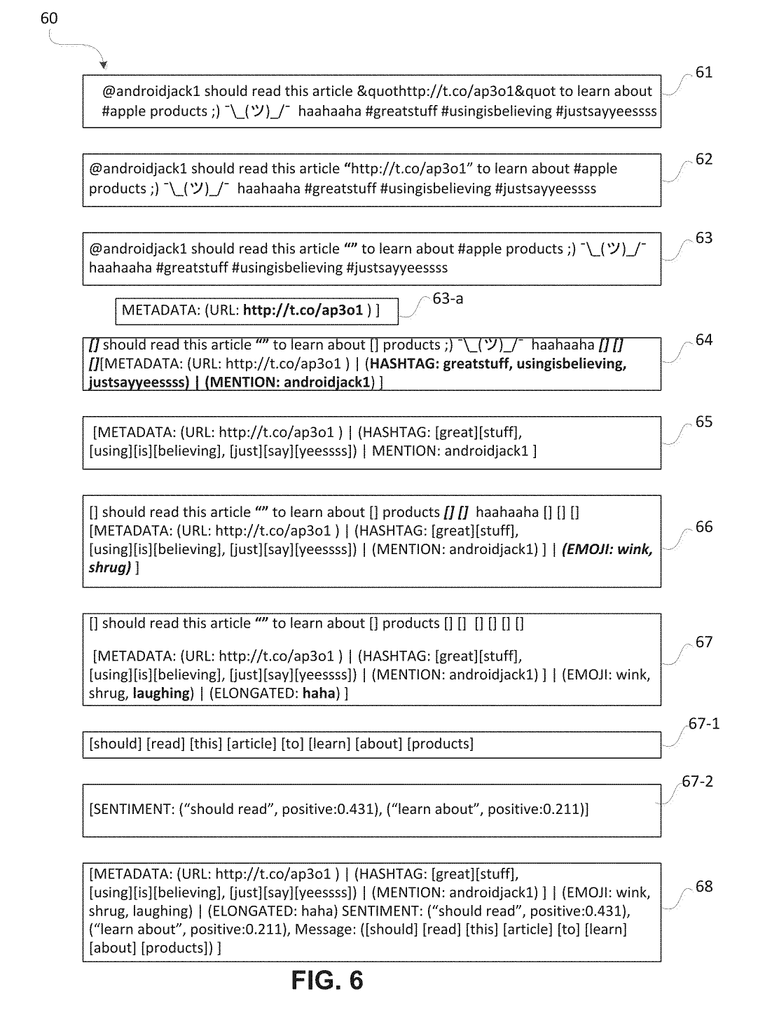

FIG. 6 is a diagram illustrating an example implementation 600 of n-gram classification of social media content, according to certain aspects of the disclosure. The example implementation 600 includes block 61-68, which show an example media content (e.g., a social media message) in block 61 and results of implementation of various processing steps of the subject technology (e.g., processes of the process 20 of FIG. 2) on the media content of block 61, which includes, markup characters, a URL a hashtags, and a mention. The first result shown in block 62 is obtained after resolving the markup characters “&quot” and converting it to quotation marks “ ” before and after the string “http://t.co/ap3o1” following the “&quot”. The second result after removing the URL (e.g., http://t.co/ap3o1) is shown in block 63. The block 63-a shows the metadata that includes the URL.

The implementation result following removal of the hashtag (#apple, #greatstuff, #usingisbelieving and #justsayyeessss) and the mention (@androidjack1) are shown along the corresponding metadata (e.g., [METADATA: (URL: http://t.co/ap3o1) (HASHTAG: greatstuff, usingisbelieving, justsayyeessss)|(MENTION: androidjack1)] in the block 64. Accumulated metadata is separately stored as shown in block 65. The next processing step is extracting and/or normalizing emoticons, and shortening elongated words (e.g., haahaaha), for which the result is shown in the blocks 66 and 67. Further, block 67-1 show the tokenized media content in the form of split words (e.g., [should] [read] [this] [article] [to] [learn] [about] [products]). The applied sentiment scores can be obtained from known tables and are shown in block 67-2. The final metadata resulting from the overall proceeding of the media content is shown in block 68.

The media content can be analyzed based on the results shown above to understand the messages. The obtained information may then be indexed, based on the presence of certain hashtags or other data points to be leveraged multiple times without having to parse the message again each time.

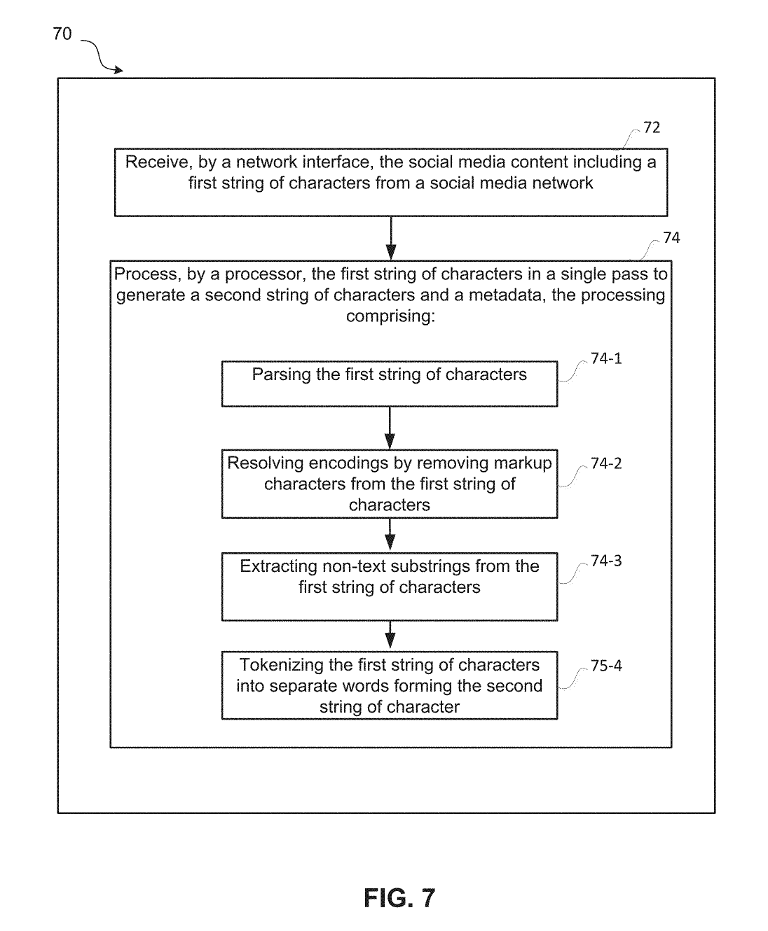

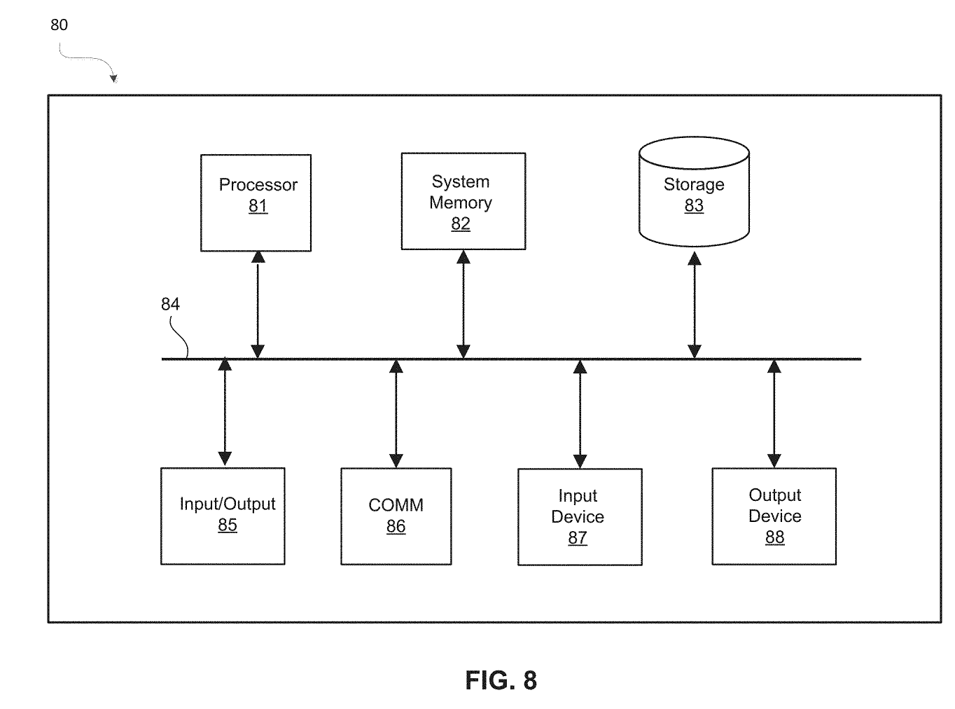

FIG. 7 is a flow diagram illustrating an example method 700 of n-gram classification of social media content (e.g., block 61 of FIG. 6), according to certain aspects of the disclosure. The method 700 includes receiving, via a network interface (e.g., 16 of FIG. 1 or 86 of FIG. 8), the social media content including a first string of characters (e.g., block 61 of FIG. 6) from a social media network (72). The method further includes processing, by a processor (e.g., processor 81 of FIG. 8), the first string of characters in a single pass to generate a second string of characters (e.g., 67-1 of FIG. 6) and a metadata (e.g., 68 of FIG. 6) (74). The processing may include parsing the first string of characters (74-1), resolving encodings (e.g., 22 of FIG. 2) by removing markup characters from the first string of characters (74-2), extracting non-text substrings (e.g., 24 of FIG. 20) from the first string of characters (74-3), and tokenizing the first string of characters into separate words (e.g., 67-1 of FIG. 6) forming the second string of characters (74-4).

FIG. 8 is a block diagram illustrating an example computer system with which certain aspects of the subject technology can be implemented. In some aspects, the computer system 80 may represent the server 11, the computing device 12 and/or the mobile devices 13 and 14 of FIG. 1. In certain aspects, the computer system 80 may be implemented using hardware or a combination of software and hardware, either in a dedicated server or integrated into another entity or distributed across multiple entities.

Computer system 80 (e.g., server 11, the computing device 12 or the portable communication devices 13 and 14) includes a bus 84 or other communication mechanism for communicating information and a processor 81 coupled with bus 84 for processing information. According to one aspect, the computer system 80 can be a cloud computing server of an infra-structure-as-a-service (IaaS) and can be able to support platform-as-a-service (PaaS) and software-as-a-service (SaaS).

Computer system 80 can include, in addition to hardware, code that creates an execution environment for the computer program in question, e.g., code that constitutes processor firmware, a protocol stack, a database management system, an operating system, or a combination of one or more of them stored in an included memory 82, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 84 for storing information and instructions to be executed by processor 81. The processor 81 and the memory 82 can be supplemented by, or incorporated in, special purpose logic circuitry.

The instructions may be stored in the memory 82 and implemented in one or more computer program products, i.e., one or more modules of computer program instructions encoded on a computer readable medium for execution by, or to control the operation of, the computer system 80, and according to any method well known to those of skill in the art.

A computer program as discussed herein does not necessarily correspond to a file in a file system. A program can be stored in a portion of a file that holds other programs or data (e.g., one or more scripts stored in a markup language document), in a single file dedicated to the program in question or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 80 further includes a data storage device 83 such as a magnetic disk or optical disk, coupled to bus 84 for storing information and instructions. Computer system 80 may be coupled via input/output module 85 to various devices. The input/output module 85 can be any input/output module. Example input/output modules 85 include data ports such as USB ports. In addition, input/output module 85 may be provided in communication with processor 81, so as to enable near area communication of computer system 80 with other devices. The input/output module 85 may provide, for example, for wired communication in some implementations or for wireless communication in other implementations, and multiple interfaces may also be used. The input/output module 85 is configured to connect to a communications module 86. Example communications modules 86 may include networking interface cards, such as Ethernet cards and modems.

In certain aspects, the input/output module 85 is configured to connect to a plurality of devices, such as an input device 87 and/or an output device 88. Example input devices 87 include a keyboard and a pointing device, e.g., a mouse or a trackball, by which a user can provide input to the computer system 80. Other kinds of input devices 87 can be used to provide for interaction with a user as well, such as a tactile input device, visual input device, audio input device or brain-computer interface device.

According to one aspect of the present disclosure, at least portions of the processes 20,30, 40 and 50 and the method 70 can be implemented using the computer system 80 in response to processor 81 executing one or more sequences of one or more instructions contained in memory 82. Such instructions may be read into memory 82 from another machine-readable medium, such as data storage device 83. Execution of the sequences of instructions contained in main memory 82 causes processor 81 to perform the process steps described herein. One or more processors in a multi-processing arrangement may also be employed to execute the sequences of instructions contained in memory 82. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware or front end components.

In one aspect, a method may be an operation, an instruction or a function and vice versa. In one aspect, a clause or a claim may be amended to include some or all of the words (e.g., instructions, operations, functions or components) recited in other one or more clauses, one or more words, one or more sentences, one or more phrases, one or more paragraphs and/or one or more claims.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A system for n-gram classification of social media content, the system comprising:
a network interface configured to receive the social media content from a social media network, the social media content including a string of characters; and
a processor configured to process the string of characters by:
resolving encodings by removing markup characters from the string of characters;
extracting non-text substrings from the string of characters; and
tokenizing the string of characters into separate words.

2. The system of claim 1, wherein the processor is configured to process the string of characters in a single pass, and wherein the processor is configured to parse the string of characters prior to resolving the encodings.

3. The system of claim 1, wherein the markup characters comprise hyper-text markup language (HTML) and other encodings, and wherein the markup characters comprise two-layer markups.

4. The system of claim 1, wherein the processor is further configured to normalize the string of characters after extracting the non-text substrings.

5. The system of claim 1, wherein the non-text substrings comprise at least one of a uniform resource locator (URL), a hashtag, a mention or an emoticon.

6. The system of claim 5, wherein the processor is further configured to store a position of the non-text substrings in the string of characters to allow a granular identification of applicable sentiments at a per-sentence or a per-phrase level.

7. The system of claim 5, wherein the processor is further configured to expand a shortened URL to a full URL, and to parse a query-string of the full URL to identify words.

8. The system of claim 5, wherein the processor is further configured to aggregate the non-text substrings as metadata and to store the metadata, wherein the metadata further comprises time stamps, user identification (ID) data.

9. The system of claim 5, wherein the processor is further configured to split hashtags into separate words via fuzzy heuristics by:
breaking mixed cased words apart,
separating irregularly cased words,
using pattern matching to separate hashtags with no case changes,
searching a dictionary for each substring within a word using a brute-force method, and
looking up a frequency score associated with an identified word within the dictionary.

10. The system of claim 1, wherein the processor is further configured to identify elongated words in the string of characters and to replace the identified elongated words with shortened words.

11. The system of claim 1, wherein the processor is further configured to identify entities by finding words that do not appear in a database of known common-words, and to separately extract groups of two or more entities to heuristically identify entity names.

12. The system of claim 1, wherein the processor is further configured to extract n-grams of progressively smaller size by iterating over the tokenized string of characters.

13. A system comprising:
memory; and
a processor coupled to the memory and configured to receive social media content including a string of characters from a social media network,
wherein the processor is further configured to process the string of characters in a single pass by:
removing encodings from the string of characters; and
extracting non-text substrings including uniform resource locators (URLs) from the string of characters.

14. The system of claim 13, further comprising tokenizing the string of characters into separate words.

15. The system of claim 14, wherein the processor is further configured to extract n-grams of progressively smaller size by iterating over the tokenized string of characters.

16. The system of claim 13, wherein the encodings comprise markup characters including hyper-text markup language (HTML).

17. The system of claim 13, wherein the non-text substrings further includes at least one of a hashtag, a mention or an emoticon, and wherein the processor is further configured to store in the memory the extracted non-text substrings as metadata and a position of the non-text substrings in the string of characters along with time stamps and user identification (ID) information.

18. The system of claim 13, wherein the processor is further configured to classify the social media content posted by a user based on determined sentiments to identify interests of the user, and to provide the identified interests of the user to one or more business entities.

19. A method of n-gram classification of social media content, comprising:
receiving, via a network interface, the social media content including a first string of characters from a social media network; and
processing, by a processor, the first string of characters in a single pass to generate a second string of characters and a metadata,
wherein the processing comprises:
resolving encodings by removing markup characters from the first string of characters;
extracting non-text substrings from the first string of characters; and
tokenizing the first string of characters into separate words forming the second string of characters.

20. The method of claim 19, wherein the non-text substrings comprise at least one of a uniform resource locator (URL), a hashtags, a mention or an emoticon, and wherein the processing further comprises:
aggregating the non-text sub strings and storing the aggregated the non-text sub strings along with time stamps and user identification (ID) data as metadata; and
splitting hashtags into separate words via fuzzy heuristics including breaking mixed cased words apart, separating irregularly cased words, using pattern matching to separate hashtags with no case changes, searching a dictionary for each substring within a word using a brute-force method, and looking up a frequency score associated with an identified word within the dictionary.
